(19) United States
(12) Patent Application Publication
(10) Pub. No.: US 2016/0105120 A1
(43) Pub. Date: Apr. 14, 2016

(54) POWER CONVERSION APPARATUS

(71) Applicant: TOYOTA JIDOSHA KABUSHIKI KAISHA, Toyota -shi, Aichi-ken (JP)

(72) Inventors: Takahiro HIRANO, Toyota-shi, Aichi-ken (JP); Kenichiro NAGASHITA, Toyota-shi, Aichi-ken (JP)

(73) Assignee: TOYOTA JIDOSHA KABUSHIKI KAISHA, Toyota-shi, Aichi-ken (JP)

(21) Appl. No.: 14/892,810

(22) PCT Filed: May 20, 2014
(86) PCT No.: PCT/IB2014/000769

§ 371 Date: Nov. 20, 2015

(30) Foreign Application Priority Data
May 21, 2013 (JP) 2013-107416

(51) Int. Cl. H02M 3/335

(52) U.S. Cl. CPC H02M 3/33546; H02M 2001/0009

(57) ABSTRACT

A power conversion apparatus includes a primary side circuit and a secondary side circuit magnetically coupled to the primary side circuit through a transformer. Transmitted power transmitted between a primary side port provided in the primary side circuit and a secondary side port provided in the secondary side circuit changes in accordance with a phase difference between switching of the primary side circuit and switching of the secondary side circuit, and a frequency of the switching of each of the primary side circuit and the secondary side circuit. The power conversion apparatus includes a control unit that adjusts the frequency in accordance with a port voltage of at least one of the primary side port and the secondary side port.

### BACKGROUND OF THE INVENTION

1. Field of the Invention

The invention relates to a power conversion performed between a primary side circuit and a secondary side circuit magnetically coupled to the primary side circuit through a transformer.

2. Description of Related Art

Power conversion apparatuses are available which enable the amount of power transmitted between a primary side circuit and a secondary side circuit to be adjusted by changing a phase difference between switching of the primary side circuit and switching of the secondary side circuit (see, for example, Japanese Patent Application Publication No. 2011-193713 (JP 2011-193713 A)).

### SUMMARY OF THE INVENTION

However, the transmitted power transmitted between the primary side circuit and the secondary side circuit may conventionally fail to be accurately adjusted. An object of the invention is to provide a power conversion apparatus that allows the transmitted power transmitted between the primary side circuit and the secondary side circuit to be accurately adjusted.

A first aspect of the invention is a power conversion apparatus includes: a primary side circuit; and a secondary side circuit magnetically coupled to the primary side circuit through a transformer. Transmitted power transmitted between a primary side port provided in the primary side circuit and a secondary side port provided in the secondary side circuit changes in accordance with a phase difference between switching of the primary side circuit and switching of the secondary side circuit, and a frequency of the switching of each of the primary side circuit and the secondary side circuit. The power conversion apparatus includes a control unit that adjusts the frequency in accordance with a port voltage of at least one of the primary side port and the secondary side port.

A second aspect of the invention is a power conversion apparatus includes: a primary side circuit; and a secondary side circuit magnetically coupled to the primary side circuit through a transformer. Transmitted power transmitted between a primary side port provided in the primary side circuit and a secondary side port provided in the secondary side circuit changes in accordance with a phase difference between switching of the primary side circuit and switching of the secondary side circuit, and a frequency of the switching of each of the primary side circuit and the secondary side circuit. The power conversion apparatus includes a control unit that adjusts the frequency in accordance with target power for the transmitted power.

The “frequency” may be interchanged with an “angular frequency”, and “adjustment of the frequency” may be interchanged with “adjustment of the angular frequency”.

According to the first and second aspects of the invention, the transmitted power transmitted between the primary side circuit and the secondary side circuit can be accurately adjusted.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing an example of a configuration of a power supply apparatus serving as an embodiment of a power conversion apparatus according to the invention;

FIG. 2 is a block diagram showing an example of a configuration of a control unit according to this embodiment;

FIG. 3 is a timing chart showing an example of switching operations of a primary side circuit and a secondary side circuit according to this embodiment;

FIG. 4 is a timing chart of a case in which a duty ratio D is relatively low according to the embodiment;

FIG. 5 is a timing chart of a case in which a duty ratio D is relatively high according to the embodiment;

FIG. 6 is a timing chart showing an example of adjustment of transmitted power P on the basis of adjustment of a switching frequency f according to the embodiment;

FIG. 7 is a flowchart showing an example of a power conversion method according to the invention; and

FIG. 8 is an example of a frequency determination map according to the invention.

### DETAILED DESCRIPTION OF EMBODIMENTS

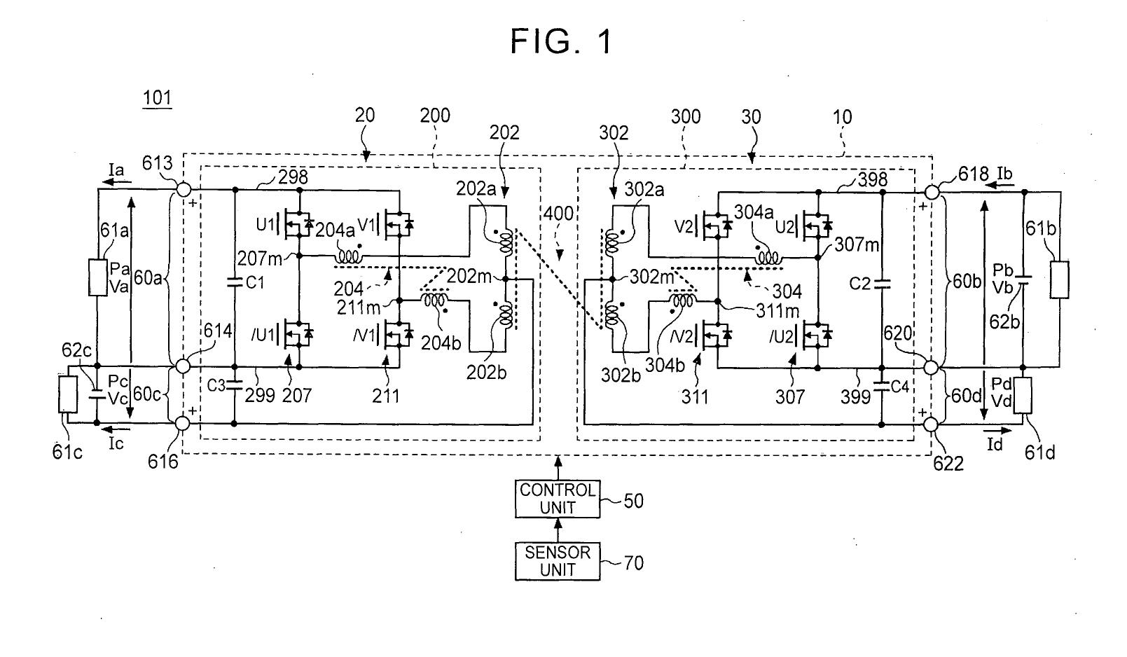

FIG. 1 is a block diagram showing an example of a configuration of a power supply apparatus 101 serving as an embodiment of a power conversion apparatus. For example, the power supply apparatus 101 is a power supply system that includes a power supply circuit 10, a control unit 50, and a sensor unit 70.

For example, the power supply apparatus 101 includes, as primary side ports, a first input/output port 60a to which a primary side high voltage system load 61a is connected and a second input/output port 60c to which a primary side low voltage system load 61c and a primary side low voltage system power supply 62c are connected. The primary side low voltage system power supply 62c supplies power to the primary side low voltage system load 61c, which is operated by an identical voltage system (a 12 V system, for example) to the primary side low voltage system power supply 62c. Further, the primary side low voltage system power supply 62c supplies power stepped up by a primary side conversion circuit 20 provided in the power supply circuit 10 to the primary side high voltage system load 61a, which is operated by a different voltage system (a higher 48 V system than the 12 V system, for example) to the primary side low voltage system power supply 62c. A secondary battery such as a lead battery may be cited as a specific example of the primary side low voltage system power supply 62c.

For example, the power supply apparatus 101 includes, as secondary side ports, a third input/output port 60b to which a secondary side high voltage system load 61b and a secondary side high voltage system power supply 62b are connected and a fourth input/output port 60d to which a secondary side low voltage system load 61d is connected. The secondary side high voltage system power supply 62b supplies power to the secondary side high voltage system load 61b, which is operated by an identical voltage system (a higher 288 V system than the 12 V system and the 48 V system, for example) to the secondary side high voltage system power supply 62b. Further, the secondary side high voltage system power supply 62b supplies power stepped up by a secondary side conversion circuit 30 provided in the power supply circuit 10 to the secondary side low voltage system load 61d, which is operated by a different voltage system (a lower 72 V system than the 288 V system, for example) to the secondary side high voltage system power supply 62b. A secondary battery such as a lithium ion battery may be cited as a specific example of the secondary side high voltage system power supply 62b.

The power supply circuit 10 is a power conversion circuit that includes the four input/output ports described above and has functions for selecting two desired input/output ports from the four input/output ports and performing power conversion between the two selected input/output ports.

Port powers Pa, Pc, Pb, Pd are input/output powers (input powers or output powers) of the first input/output port 60a, the second input/output port 60c, the third input/output port 60b, and the fourth input/output port 60d, respectively. Port voltages Va, Vc, Vb, Vd are input/output voltages (input voltages or output voltages) of the first input/output port 60a, the second input/output port 60c, the third input/output port 60b, and the fourth input/output port 60d, respectively. Port currents Ia, Ic, Ib, Id are input/output currents (input currents or output currents) of the first input/output port 60a, the second input/output port 60c, the third input/output port 60b, and the fourth input/output port 60d, respectively.

The power supply circuit 10 includes a capacitor C1 provided in the first input/output port 60a, a capacitor C3 provided in the second input/output port 60c, a capacitor C2 provided in the third input/output port 60b, and a capacitor C4 provided in the fourth input/output port 60d. Film capacitors, aluminum electrolytic capacitors, ceramic capacitors, polymer electrolytic capacitors, and so on may be cited as specific examples of the capacitors C1, C2, C3, C4.

The capacitor C1 is inserted between a high potential side terminal 613 of the first input/output port 60a and a low potential side terminal 614 of the first input/output port 60a and the second input/output port 60c. The capacitor C3 is inserted between a high potential side terminal 616 of the second input/output port 60c and the low potential side terminal 614 of the first input/output port 60a and the second input/output port 60c. The capacitor C2 is inserted between a high potential side terminal 618 of the third input/output port 60b and a low potential side terminal 620 of the third input/output port 60b and the fourth input/output port 60d. The capacitor C4 is inserted between a high potential side terminal 622 of the fourth input/output port 60d and the low potential side terminal 620 of the third input/output port 60b and the fourth input/output port 60d.

The capacitors C1, C2, C3, C4 may be provided either inside or outside the power supply circuit 10.

The power supply circuit 10 is a power conversion circuit configured to include the primary side conversion circuit 20 and the secondary side conversion circuit 30. Note that the primary side conversion circuit 20 and the secondary side conversion circuit 30 are connected via a primary side magnetic coupling reactor 204 and a secondary side magnetic coupling reactor 304, and magnetically coupled by a transformer 400 (a center tapped transformer).

The primary side conversion circuit 20 is a primary side circuit configured to include a primary side full bridge circuit 200, the first input/output port 60a, and the second input/output port 60c. The primary side full bridge circuit 200 is a primary side power conversion unit configured to include a primary side coil 202 of the transformer 400, the primary side magnetic coupling reactor 204, a primary side first upper arm U1, a primary side first lower arm /U1, a primary side second upper arm V1, and a primary side second lower arm /V1. Here, the primary side first upper arm U1, the primary side first lower arm /U1, the primary side second upper arm V1, and the primary side second lower arm /V1 are constituted by switching elements respectively configured to include, for example, an N channel type metal oxide semiconductor field effect transistor (MOSFET) and a body diode serving as a parasitic element of the MOSFET. Additional diodes may be connected to the MOSFET in parallel.

The primary side full bridge circuit 200 includes a primary side positive electrode bus line 298 connected to the high potential side terminal 613 of the first input/output port 60a, and a primary side negative electrode bus line 299 connected to the low potential side terminal 614 of the first input/output port 60a and the second input/output port 60c.

A primary side first arm circuit 207 connecting the primary side first upper arm U1 and the primary side first lower arm /U1 in series is attached between the primary side positive electrode bus line 298 and the primary side negative electrode bus line 299. The primary side first arm circuit 207 is a primary side first power conversion circuit unit (a primary side U phase power conversion circuit unit) capable of performing a power conversion operation by switching the primary side first upper arm U1 and the primary side first lower arm /U1 ON and OFF. Further, a primary side second arm circuit 211 connecting the primary side second upper arm V1 and the primary side second lower arm /V1 in series is attached between the primary side positive electrode bus line 298 and the primary side negative electrode bus line 299 in parallel with the primary side first arm circuit 207. The primary side second arm circuit 211 is a primary side second power conversion circuit unit (a primary side V phase power conversion circuit unit) capable of performing a power conversion operation by switching the primary side second upper arm V1 and the primary side second lower arm /V1 ON and OFF.

The primary side coil 202 and the primary side magnetic coupling reactor 204 are provided in a bridge part connecting a midpoint 207m of the primary side first arm circuit 207 to a midpoint 211m of the primary side second arm circuit 211. To describe connection relationships to the bridge part in more detail, one end of a primary side first reactor 204a of the primary side magnetic coupling reactor 204 is connected to the midpoint 207m of the primary side first arm circuit 207, and one end of the primary side coil 202 is connected to another end of the primary side first reactor 204a. Further, one end of a primary side second reactor 204b of the primary side magnetic coupling reactor 204 is connected to another end of the primary side coil 202, and another end of the primary side second reactor 204b is connected to the midpoint 211m of the primary side second arm circuit 211. Note that the primary side magnetic coupling reactor 204 is configured to include the primary side first reactor 204a and the primary side second reactor 204b, which is magnetically coupled to the primary side first reactor 204a by a coupling coefficient k₁.

The midpoint 207m is a primary side first intermediate node between the primary side first upper arm U1 and the primary side first lower arm /U1, and the midpoint 211m is a primary side second intermediate node between the primary side second upper arm V1 and the primary side second lower arm /V1.

The first input/output port 60a is a port provided between the primary side positive electrode bus line 298 and the primary side negative electrode bus line 299. The first input/output port 60a is configured to include the terminal 613 and the terminal 614. The second input/output port 60c is a port provided between the primary side negative electrode bus line 299 and a center tap 202m of the primary side coil 202. The second input/output port 60c is configured to include the terminal 614 and the terminal 616.

The center tap 202m is connected to the high potential side terminal 616 of the second input/output port 60c. The center tap 202m is an intermediate connection point between a primary side first winding 202a and a primary side second winding 202b constituting the primary side coil 202.

The secondary side conversion circuit 30 is a secondary side circuit configured to include a secondary side full bridge circuit 300, the third input/output port 60b, and the fourth input/output port 60d. The secondary side full bridge circuit 300 is a secondary side power conversion unit configured to include a secondary side coil 302 of the transformer 400, the secondary side magnetic coupling reactor 304, a secondary side first upper arm U2, a secondary side first lower arm /U2, a secondary side second upper arm V2, and a secondary side second lower arm /V2. Here, the secondary side first upper arm U2, the secondary side first lower arm /U2, the secondary side second upper arm V2, and the secondary side second lower arm /V2 are constituted by switching elements respectively configured to include, for example, an N channel type MOSFET and a body diode serving as a parasitic element of the MOSFET. Additional diodes may be connected to the MOSFET in parallel.

The secondary side full bridge circuit 300 includes a secondary side positive electrode bus line 398 connected to the high potential side terminal 618 of the third input/output port 60b, and a secondary side negative electrode bus line 399 connected to the low potential side terminal 620 of the third input/output port 60b and the fourth input/output port 60d.

A secondary side first arm circuit 307 connecting the secondary side first upper arm U2 and the secondary side first lower arm /U2 in series is attached between the secondary side positive electrode bus line 398 and the secondary side negative electrode bus line 399. The secondary side first arm circuit 307 is a secondary side first power conversion circuit unit (a secondary side U phase power conversion circuit unit) capable of performing a power conversion operation by switching the secondary side first upper arm U2 and the secondary side first lower arm /U2 ON and OFF. Further, a secondary side second arm circuit 311 connecting the secondary side second upper arm V2 and the secondary side second lower arm /V2 in series is attached between the secondary side positive electrode bus line 398 and the secondary side negative electrode bus line 399 in parallel with the secondary side first arm circuit 307. The secondary side second arm circuit 311 is a secondary side second power conversion circuit unit (a secondary side V phase power conversion circuit unit) capable of performing a power conversion operation by switching the secondary side second upper arm V2 and the secondary side second lower arm /V2 ON and OFF.

The secondary side coil 302 and the secondary side magnetic coupling reactor 304 are provided in a bridge part connecting a midpoint 307m of the secondary side first arm circuit 307 to a midpoint 311m of the secondary side second arm circuit 311. To describe connection relationships to the bridge part in more detail, one end of a secondary side first reactor 304a of the secondary side magnetic coupling reactor 304 is connected to the midpoint 307m of the secondary side first arm circuit 307, and one end of the secondary side coil 302 is connected to another end of the secondary side first reactor 304a. Further, one end of a secondary side second reactor 304b of the secondary side magnetic coupling reactor 304 is connected to another end of the secondary side coil 302, and another end of the secondary side second reactor 304b is connected to the midpoint 311m of the secondary side second arm circuit 311. Note that the secondary side magnetic coupling reactor 304 is configured to include the secondary side first reactor 304a and the secondary side second reactor 304b, which is magnetically coupled to the secondary side first reactor 304a by a coupling coefficient k₂.

The midpoint 307m is a secondary side first intermediate node between the secondary side first upper arm U2 and the secondary side first lower arm /U2, and the midpoint 311m is a secondary side second intermediate node between the secondary side second upper arm V2 and the secondary side second lower arm /V2.

The third input/output port 60b is a port provided between the secondary side positive electrode bus line 398 and the secondary side negative electrode bus line 399. The third input/output port 60b is configured to include the terminal 618 and the terminal 620. The fourth input/output port 60d is a port provided between the secondary side negative, electrode bus line 399 and a center tap 302m of the secondary side coil 302. The fourth input/output port 60d is configured to include the terminal 620 and the terminal 622.

The center tap 302m is connected to the high potential side terminal 622 of the fourth input/output port 60d. The center tap 302m is an intermediate connection point between a secondary side first winding 302a and a secondary side second winding 302b constituting the secondary side coil 302.

In FIG. 1, the power supply apparatus 101 includes the sensor unit 70. The sensor unit 70 serves as detecting means that detects an input/output value Y of at least one of the first to fourth input/output ports 60a, 60c, 60b, 60d at predetermined detection period intervals and outputs a detection value Yd corresponding to the detected input/output value Y to the control unit 50. The detection value Yd may be a detected voltage obtained by detecting the input/output voltage, a detected current obtained by detecting the input/output current, or a detected power obtained by detecting the input/output power. The sensor unit 70 may be provided either inside or outside the power supply circuit 10.

The sensor unit 70 includes, for example, a voltage detection unit that detects the input/output voltage generated in at least one of the first to fourth input/output ports 60a, 60c, 60b, 60d. For example, the sensor unit 70 includes a primary side voltage detection unit that outputs at least one detected voltage from among an input/output voltage Va and an input/output voltage Vc as a primary side voltage detection value, and a secondary side voltage detection unit that outputs at least one detected voltage from among an input/output voltage Vb and an input/output voltage Vd as a secondary side voltage detection value.

The voltage detection unit of the sensor unit 70 includes, for example, a voltage sensor that monitors an input/output voltage value of at least one port, and a voltage detection circuit that outputs a detected voltage corresponding to the input/output voltage value monitored by the voltage sensor to the control unit 50.

The sensor unit 70 includes, for example, a current detection unit that detects the input/output current flowing through at least one of the first to fourth input/output ports 60a, 60c, 60b, 60d. For example, the sensor unit 70 includes a primary side current detection unit that outputs at least one detected current from among an input/output current Ia and an input/output current Ic as a primary side current detection value, and a secondary side current detection unit that outputs at least one detected current from among an input/output current Ib and an input/output current Id as a secondary side current detection value.

The current detection unit of the sensor unit 70 includes, for example, a current sensor that monitors an input/output current value of at least one port, and a current detection circuit that outputs a detected current corresponding to the input/output current value monitored by the current sensor to the control unit 50.

The power supply apparatus 101 includes the control unit 50. For example, the control unit 50 is an electronic circuit that includes a microcomputer having an inbuilt central processing unit (CPU). The control unit 50 may be provided either inside or outside the power supply circuit 10.

The control unit 50 feedback-controls a power conversion operation performed by the power supply circuit 10 such that the detected value Yd of the input/output value Y of at least one of the first to fourth input/output ports 60a, 60c, 60b, 60d converges to a target value Yo set in the port. For example, the target value Yo is a command value set by the control unit 50 or a predetermined apparatus other than the control unit 50 on the basis of driving conditions defined in relation to the respective loads (the primary side low voltage system load 61c and so on, for example) connected to the input/output ports. The target value Yo functions as an output target value when power is output from the port and an input target value when power is input into the port, and may be a target voltage value, a target current value, or a target power value.

Further, the control unit 50 feedback-controls the power conversion operation performed by the power supply circuit 10 such that a transmitted power P transmitted between the primary side conversion circuit 20 and the secondary side conversion circuit 30 via the transformer 400 converges to a set target transmitted power Po. The transmitted power will also be referred to as a power transmission amount. For example, the target transmitted power Po is a command value set by the control unit 50 or a predetermined apparatus other than the control unit 50 on the basis of a deviation between the detected value Yd and the target value Yo in one of the ports.

The control unit 50 feedback-controls the power conversion operation performed by the power supply circuit 10 by varying a value of a predetermined control parameter X, and is thus capable of adjusting the respective input/output values Y of the first to fourth input/output ports 60a, 60c, 60b, 60d of the power supply circuit 10. Two control variables, namely a phase difference φ and a duty ratio D (an ON time δ) are used as the main control parameters X.

The phase difference φ is a deviation (a time lag) between switching timings of identical-phase power conversion circuit units of the primary side full bridge circuit 200 and the secondary side full bridge circuit 300. The duty ratio D (the ON time δ) is a duty ratio (an ON time) between switching waveforms of the respective power conversion circuit units constituting the primary side full bridge circuit 200 and the secondary side full bridge circuit 300.

The two control parameters X can be controlled independently of each other. The control unit 50 varies the input/output values Y of the respective input/output ports of the power supply circuit 10 by performing duty ratio control and/or phase control on the primary side full bridge circuit 200 and the secondary side full bridge circuit 300 using the phase difference φ and the duty ratio D (the ON time δ).

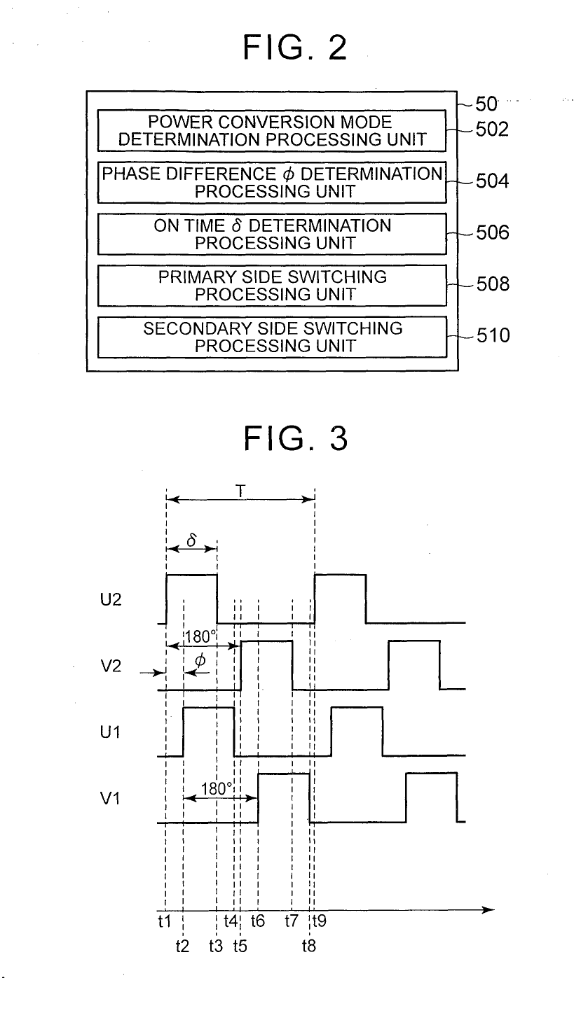

FIG. 2 is a block diagram of the control unit 50. The control unit 50 is a control unit having a function for performing switching control on the respective switching elements of the primary side conversion circuit 20, such as the primary side first upper arm U1, and the respective switching elements of the secondary side conversion circuit 30, such as the secondary side first upper arm U2. The control unit 50 is configured to include a power conversion mode determination processing unit 502, a phase difference φ determination processing unit 504, an ON time δ determination processing unit 506, a primary side switching processing unit 508, and a secondary side switching processing unit 510. For example, the control unit 50 is an electronic circuit that includes a microcomputer having an inbuilt CPU.

For example, the power conversion mode determination processing unit 502 selects and sets an operating mode from among power conversion modes A to L of the power supply circuit 10, to be described below, on the basis of a predetermined external signal (for example, a signal indicating the deviation between the detected value Yd and the target value Yo in one of the ports). As regards the power conversion modes, in mode A, power input from the first input/output port 60a is converted and output to the second input/output port 60c. In mode B, power input from the first input/output port 60a is converted and output to the third input/output port 60b. In mode C, power input from the first input/output port 60a is converted and output to the fourth input/output port 60d.

In mode D, power input from the second input/output port 60c is converted and output to the first input/output port 60a. In mode E, power input from the second input/output port 60c is converted and output to the third input/output port 60b. In mode F, power input from the second input/output port 60c is converted and output to the fourth input/output port 60d.

In mode G, power input from the third input/output port 60b is converted and output to the first input/output port 60a. In mode H, power input from the third input/output port 60b is converted and output to the second input/output port 60c. In mode I, power input from the third input/output port 60b is converted and output to the fourth input/output port 60d.

In mode J, power input from the fourth input/output port 60d is converted and output to the first input/output port 60a. In mode K, power input from the fourth input/output port 60d is converted and output to the second input/output port 60c. In mode L, power input from the fourth input/output port 60d is converted and output to the third input/output port 60b.

The phase difference φ determination processing unit 504 has a function for setting a phase difference φ between switching period motions of the switching elements between the primary side conversion circuit 20 and the secondary side conversion circuit 30 in order to cause the power supply circuit 10 to function as a DC-DC converter circuit.

The ON time δ determination processing unit 506 has a function for setting an ON time δ of the switching elements of the primary side conversion circuit 20 and the secondary side conversion circuit 30 in order to cause the primary side conversion circuit 20 and the secondary side conversion circuit 30 to function respectively as step-up/step-down circuits.

The primary side switching processing unit 508 has a function for performing switching control on the respective switching elements constituted by the primary side first upper arm U1, the primary side first lower arm /U1, the primary side second upper arm V1, and the primary side second lower arm /V1, on the basis of outputs of the power conversion mode determination processing unit 502, the phase difference φ determination processing unit 504, and the ON time δ determination processing unit 506.

The secondary side switching processing unit 510 has a function for performing switching control, on the respective switching elements constituted by the secondary side first upper arm U2, the secondary side first lower arm /U2, the secondary side second upper arm V2, and the secondary side second lower arm /V2, on the basis of the outputs of the power conversion mode determination processing unit 502, the phase difference φ determination processing unit 504, and the ON time δ determination processing unit 506.

An operation of the power supply apparatus 101 having the above configuration will now be described using FIGS. 1 and 2. When, for example, an external signal requesting an operation in which the power conversion mode of the power supply circuit 10 is set at mode F is input, the power conversion mode determination processing unit 502 of the control unit 50 sets the power conversion mode of the power supply circuit 10 to mode F. At this time, a voltage input into the second input/output port 60c is stepped up by a step-up function of the primary side conversion circuit 20, whereupon power having the stepped-up voltage is transmitted to the third input/output port 60b side by a DC-DC converter circuit function of the power supply circuit 10, stepped down by a step-down function of the secondary side conversion circuit 30, and then output from the fourth input/output port 60d.

Here, a step-up/step-down function of the primary side conversion circuit 20 will be described in detail. Focusing on the second input/output port 60c and the first input/output port 60a, the terminal 616 of the second input/output port 60c is connected to the midpoint 207m of the primary side first arm circuit 207 via the primary side first winding 202a and the primary side first reactor 204a connected in series to the primary side first winding 202a. Respective ends of the primary side first arm circuit 207 are connected to the first input/output port 60a, and as a result, a step-up/step-down circuit is attached between the terminal 616 of the second input/output port 60c and the first input/output port 60a.

The terminal 616 of the second input/output port 60c is also connected to the midpoint 211m of the primary side second arm circuit 211 via the primary side second winding 202b and the primary side second reactor 204b connected in series to the primary side second winding 202b. Respective ends of the primary side second arm circuit 211 are connected to the first input/output port 60a, and as a result, a step-up/step-down circuit is attached in parallel between the terminal 616 of the second input/output port 60c and the first input/output port 60a. Note that since the secondary side conversion circuit 30 is a circuit having a substantially identical configuration to the primary side conversion circuit 20, two step-up/step-down circuits are likewise connected in parallel between the terminal 622 of the fourth input/output port 60d and the third input/output port 60b. Hence, the secondary side conversion circuit 30 has an identical step-up/step-down function to the primary side conversion circuit 20.

Next, the function of the power supply circuit 10 as a DC-DC converter circuit will be described in detail. Focusing on the first input/output port 60a and the third input/output port 60b, the primary side full bridge circuit 200 is connected to the first input/output port 60a, and the secondary side full bridge circuit 300 is connected to the third input/output port 60b. When the primary side coil 202 provided in the bridge part of the primary side full bridge circuit 200 and the secondary side coil 302 provided in the bridge part of the secondary side full bridge circuit 300 are magnetically coupled by a coupling coefficient k_{T}, the transformer 400 functions as a center tapped transformer having a number of windings 1:N. Hence, by adjusting the phase difference φ between the switching period motions of the switching elements in the primary side full bridge circuit 200 and the secondary side full bridge circuit 300, power input into the first input/output port 60a can be converted and transmitted to the third input/output port 60b or power input into the third input/output port 60b can be converted and transmitted to the first input/output port 60a.

FIG. 3 is a view showing a timing chart of ON/OFF switching waveforms of the respective arms provided in the power supply circuit 10 resulting from control executed by the control unit 50. In FIG. 3, U1 is an ON/OFF waveform of the primary side first upper arm U1, V1 is an ON/OFF waveform of the primary side second upper arm V1, U2 is an ON/OFF waveform of the secondary side first upper arm U2, and V2 is an ON/OFF waveform of the secondary side second upper arm V2. ON/OFF waveforms of the primary side first lower arm /U1, the primary side second lower arm /V1, the secondary side first lower arm /U2, and the secondary side second lower arm /V2 are inverted waveforms (not shown) obtained by respectively inverting the ON/OFF waveforms of the primary side first upper arm U1, the primary side second upper arm V1, the secondary side first upper arm U2, and the secondary side second upper arm V2. Note that dead time is preferably provided between the respective ON/OFF waveforms of the upper and lower arms to prevent a through current from flowing when both the upper and lower arms are switched ON. Further, in FIG. 3, a high level indicates an ON condition and a low level indicates an OFF condition.

Here, by modifying the respective ON times δ of U1, V1, U2, and V2, step-up/step-down ratios of the primary side conversion circuit 20 and the secondary side conversion circuit 30 can be modified. For example, by making the respective ON times δ of U1, V1, U2, and V2 equal to each other, the step-up/step-down ratio of the primary side conversion circuit 20 can be made equal to the step-up/step-down ratio of the secondary side conversion circuit 30.

The ON time δ determination processing unit 506 make the respective ON times δ of U1, V1, U2, and V2 equal to each other (respective ON times δ=primary side ON time δ1=secondary side ON time δ2=time value α) so that the respective step-up/step-down ratios of the primary side conversion circuit 20 and the secondary side conversion circuit 30 are equal to each other.

The step-up/step-down ratio of the primary side conversion circuit 20 is determined by the duty ratio D, which is a proportion of a switching period T of the switching elements (arms) constituting the primary side full bridge circuit 200 occupied by the ON time δ. Similarly, the step-up/step-down ratio of the secondary side conversion circuit 30 is determined by the duty ratio D, which is a proportion of the switching period T of the switching elements (arms) constituting the secondary side full bridge circuit 300 occupied by the ON time δ. The step-up/step-down ratio of the primary side conversion circuit 20 is a transformation ratio between the first input/output port 60a and the second input/output port 60c, while the step-up/step-down ratio of the secondary side conversion circuit 30 is a transformation ratio between the third input/output port 60b and the fourth input/output port 60d.

Therefore, for example,

the step-up/step-down ratio of the primary side conversion circuit 20=the voltage of the second input/output port 60c/the voltage of the first input/output port 60a=δ1/T=α/T,

and the step-up/step-down ratio of the secondary side conversion circuit 30=the voltage of the fourth input/output port 60d/the voltage of the third input/output port 60b=δ2/T=α/T.

In other words, the respective step-up/step-down ratios of the primary side conversion circuit 20 and the secondary side conversion circuit 30 take identical values (=α/T).

Note that the ON time δ in FIG. 3 represents both the ON time δ1 of the primary side first upper arm U11 and the primary side second upper arm V1 and the ON time δ2 of the secondary side first upper arm U2 and the secondary side second upper arm V2. Further, the switching period T of the arms constituting the primary side full bridge circuit 200 and the switching period T of the arms constituting the secondary side full bridge circuit 300 are equal times.

Furthermore, a phase difference between U1 and V1 is activated at 180 degrees (π), and a phase difference between U2 and V2 is likewise activated at 180 degrees (π). Moreover, by changing the phase difference φ between U1 and U2, the power transmission amount P between the primary side conversion circuit 20 and the secondary side conversion circuit 30 can be adjusted such that when the phase difference φ>0, power can be transmitted from the primary side conversion circuit 20 to the secondary side conversion circuit 30, and when the phase difference φ<0, power can be transmitted from the secondary side conversion circuit 30 to the primary side conversion circuit 20.

The phase difference φ is a deviation (a time lag) between the switching timings of identical-phase power conversion circuit units of the primary side full bridge circuit 200 and the secondary side full bridge circuit 300. For example, the phase difference φ is a deviation between the switching timings of the primary side first arm circuit 207 and the secondary side first arm circuit 307, and a deviation between the switching timings of the primary side second arm circuit 211 and the secondary side second arm circuit 311. These deviations are controlled to be equal to each other. In other words, the phase difference φ between U1 and U2 and the phase difference φ between V1 and V2 are controlled to identical values.

Hence, when, for example, an external signal requesting an operation in which the power conversion mode of the power supply circuit 10 is set at mode F is input, the power conversion mode determination processing unit 502 selects and sets mode F. The ON time δ determination processing unit 506 then sets the ON time δ to define a step-up ratio required when the primary side conversion circuit 20 is caused to function as a step-up circuit that steps up the voltage input into the second input/output port 60c and outputs the stepped-up voltage to the first input/output port 60a. Note that the secondary side conversion circuit 30 functions as a step-down circuit that steps down the voltage input into the third input/output port 60b at a step-down ratio defined in accordance with the ON time δ set by the ON time δ determination processing unit 506, and outputs the stepped-down voltage to the fourth input/output port 60d. Further, the phase difference φ determination processing unit 504 sets the phase difference φ such that the power input into the first input/output port 60a is transmitted to the third input/output port 60b in the desired power transmission amount P.

The primary side switching processing unit 508 performs switching control on the respective switching elements constituted by the primary side first upper arm U1, the primary side first lower arm /U1, the primary side second upper arm V1, and the primary side second lower arm /V1 to cause the primary side conversion circuit 20 to function as a step-up circuit and to cause the primary side conversion circuit 20 to function as a part of a DC-DC converter circuit.

The secondary side switching processing unit 510 performs switching control on the respective switching elements constituted by the secondary side first upper arm U2, the secondary side first lower arm /U2, the secondary side second upper arm V2, and the secondary side second lower arm /V2 to cause the secondary side conversion circuit 30 to function as a step-down circuit and to cause the secondary side conversion circuit 30 to function as a part of a DC-DC converter circuit.

As described above, the primary side conversion circuit 20 and the secondary side conversion circuit 30 can be caused to function as a step-up circuit or a step-down circuit, and the power supply circuit 10 can be caused to function as a bidirectional DC-DC converter circuit. Therefore, power conversion can be performed in all of the power conversion modes. A to L, or in other words, power conversion can be performed between two input/output ports selected from the four input/output ports.

The transmitted power P (also referred to as the power transmission amount P) adjusted by the control unit 50 in accordance with the phase difference φ is power transmitted from one of the primary side conversion circuit 20 and the secondary side conversion circuit 30 to the other via the transformer 400, and is expressed as

P=(N×Va×Vb)/(π×ω×L)×F(D, φ) Equation 1

Note that N is a winding ratio of the transformer 400, Va is the input/output voltage of the first input/output port 60a, Vb is the input/output voltage of the third input/output port 60b, π is pi, ω(=2π×f=2π/T) is an angular frequency of the switching operations of the primary side conversion circuit 20 and the secondary side conversion circuit 30, f is a switching frequency of the primary side conversion circuit 20 and the secondary side conversion circuit 30, T is the switching period of the primary side conversion circuit 20 and the secondary side conversion circuit 30, L is an equivalent inductance of the magnetic coupling reactors 204, 304 and the transformer 400 relating to power transmission, and F (D, φ) is a function having the duty ratio D and the phase difference φ as variables and a variable that increases monotonically as the phase difference φ increases, independently of the duty ratio D.

There is a trade-off relation between the duty ratio D for adjustment of a step-up/step down ratio and the phase difference φ for adjustment of the transmitted power P.

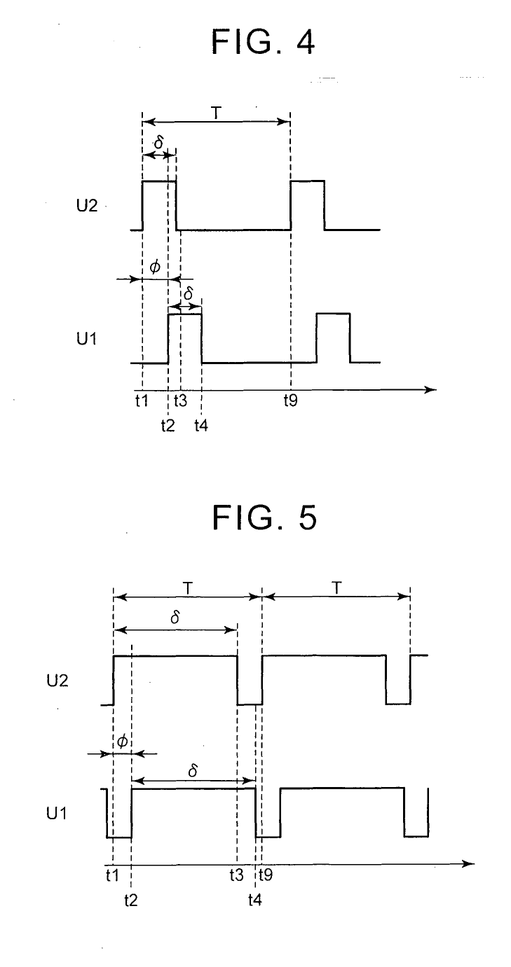

FIG. 4 is a timing chart of a case in which the duty ratio D is relatively low. As in the case of FIG. 3, the ON/OFF waveform of the primary side first upper arm U1 is denoted by UI. The ON/OFF waveform of the secondary side first upper arm U2 is denoted by U2.

For the correct transmission of the transmitted power P, the ON time δ of U1 and the ON time δ of U2 need to overlap during one switching period T. For example, as shown in FIG. 4, a timing t2 for a rising edge of an ON pulse of U1 needs to be earlier than a timing t3 for a falling edge of an ON pulse of U2. Thus, when the duty ratio D is relatively low, the possible maximum value of the phase difference φ is small, limiting the possible maximum value of the transmitted power P.

FIG. 5 is a timing chart of a case in which the duty ratio D is relatively high. As in the case of FIG. 4, the ON/OFF waveform of the primary side first upper arm U1 is denoted by U1. The ON/OFF waveform of the secondary side first upper arm U2 is denoted by U2.

For the correct transmission of the transmitted power P, the ON time δ of U1 and the ON time δ of U2 need to avoid overlapping during the ON time of the next switching period T. For example, as shown in FIG. 5, a timing t4 for a falling edge of U1 needs to be earlier than a timing t9 for a rising edge of U2 during the next switching period T. Therefore, when the duty ratio D is relatively high, the possible maximum value of the phase difference φ is also small, limiting the possible maximum value of the transmitted power P.

As described above, the maximum value of the phase difference φ is limited both when the duty ratio D is excessively low and when the duty ratio D is excessively high. Thus, the magnitude of the transmitted power P may be limited depending on the value of the duty ratio D.

On the other hand, Equation 1 indicates that the transmitted power P increases with decreasing angular frequency ω(=2π×f). Furthermore, the power supply circuit 10 is characterized in that, even with a change in the angular frequency ω, a constant duty ratio D prevents the step-up/step down ratio from changing.

Thus, the control unit 50 adjusts the angular frequency ω (in other words, the switching frequency f) in accordance with the port voltage of at least one of the primary side port or the secondary side port. Thus, even when the phase difference φ is limited by the above-described trade-off to prevent the transmitted power P from being adjusted on the basis of the phase difference φ, the transmitted power P can be accurately adjusted by regulating the angular frequency ω (switching frequency f).

The control unit 50, for example, adjusts the switching frequency f so that a change in the port voltage is suppressed using the transmitted power P. Thus, for example, even when the transmitted power P fails to be adjusted using the phase difference φ, the transmitted power P can be accurately adjusted to a value that enables a change in the port voltage to be suppressed.

The control unit 50, for example, adjustably reduces the switching frequency f so as to increase the transmitted power P transmitted to one of the primary side port and the secondary side port at which the voltage drops. Consequently, even when either one of the primary side port and the secondary side port has a power shortage and thus a reduced port voltage, the reduced port voltage can be raised by increasing the amount of transmitted power P supplied.

For example, upon detecting, during transmission of the transmitted power P, a decrease in the port voltage of one of the primary side port and the secondary side port to which the transmitted power P is transmitted, the control unit 50 adjustably reduces the switching frequency f so as to increase the transmitted power P. This increases the power consumption of a load connected to the transmission destination port. Hence, even when the voltage of the transmission destination port decreases as a result of power shortage, the port voltage of the transmission destination can be raised by increasing the amount of transmitted power P supplied.

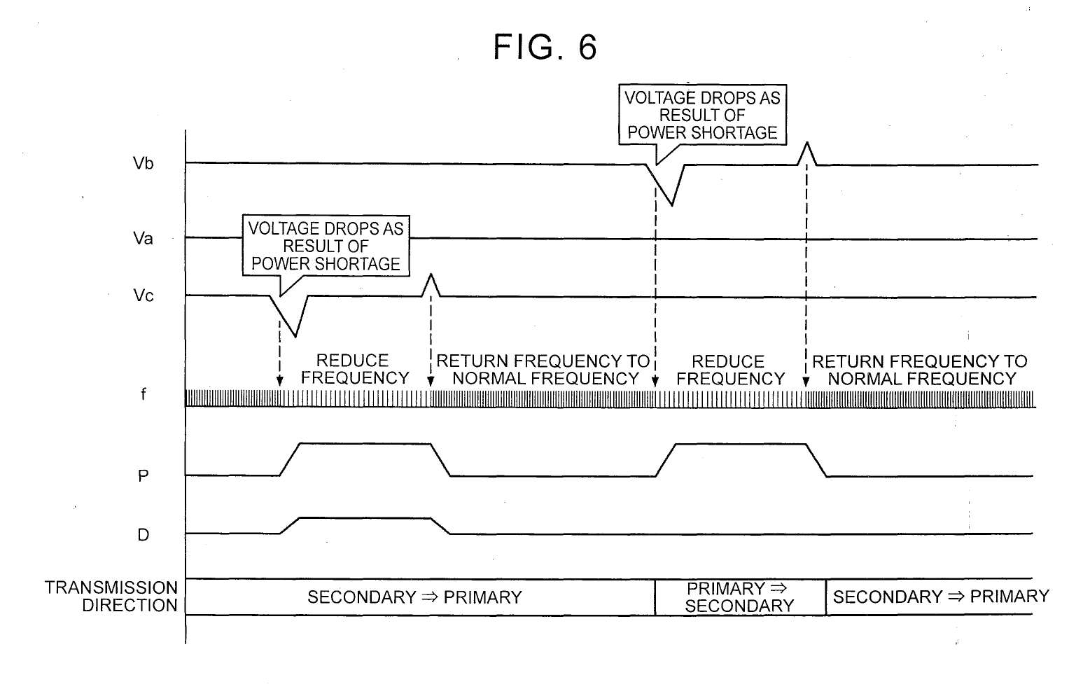

For example, in FIG. 6, if the port voltage Vc of the second input/output port 60c to which the transmitted power P is transmitted drops during transmission of the transmitted power P from the secondary side to the primary side, the control unit 50 adjusts the switching frequency f to a value smaller than a normal value so as to increase the transmitted power P. Thus, for example, even with a decrease in the port voltage Vc, the port voltage Vc can be raised by increasing the amount of transmitted power P supplied.

On the basis of detection of a decrease in the port voltage Vc, the control unit 50 may increase the duty ratio D to allow power to be fed from the first input/output port 60a to the second input/output port 60c.

For example, upon detecting, during transmission of the transmitted power P, a decrease in the port voltage of one of the primary side port and the secondary side port from which the transmitted power P is transmitted, the control unit 50 switches the transmission direction of the transmitted power P and adjustably reduces the switching frequency f so as to increase the transmitted power P. Thus, for example, even when the power consumption of the load connected to the transmission source port increases to lower the voltage of the transmission source port as a result of power shortage, the port voltage of the transmission source port obtained before the switching of the transmission direction can be raised by switching the transmission direction to the opposite direction and then increasing the amount of transmitted power P supplied.

For example, in FIG. 6, if the port voltage Vb of the third input/output port 60b from which the transmitted power P is transmitted drops during transmission of the transmitted power P from the secondary side to the primary side, the control unit 50 switches the transmission direction of the transmitted power P from the primary side to the secondary side, and then, adjusts the switching frequency f to a value smaller than the normal value so as to increase the transmitted power P. Thus, for example, even with a decrease in the port voltage Vb, the port voltage Vb can be raised by switching the transmission direction to the opposite direction and then increasing the amount of transmitted power P supplied.

Furthermore, the control unit 50 may adjust the switching frequency f to a value smaller than the normal value so as to increase the transmitted power P transmitted from one of the primary side port and the secondary side port at which the voltage rises. Consequently, even when either one of the primary side port and the secondary side port has an excessive amount of power and thus an increased port voltage, the increased port voltage can be lowered by increasing the amount of transmitted power P withdrawn.

For example, upon detecting, during transmission of the transmitted power P, an increase in the port voltage of one of the primary side port and the secondary side port from which the transmitted power P is transmitted, the control unit 50 may adjustably reduce the switching frequency f so as to increase the transmitted power P. Thus, for example, even when the power consumption of the load connected to the transmission source port decreases to raise the voltage of the transmission source port as a result of excessive power, the port voltage of the transmission source can be lowered by increasing the amount of transmitted power P withdrawn.

For example, upon detecting, during transmission of the transmitted power P, an increase in the port voltage of one of the primary side port and the secondary side port to which the transmitted power P is transmitted, the control unit 50 switches the transmission direction of the transmitted power P and adjustably reduces the switching frequency f so as to increase the transmitted power P. Thus, for example, even when the power consumption of the load connected to the transmission destination port decreases to raise the voltage of the transmission destination port as a result of excessive power, the port voltage of the transmission destination port obtained before the switching of the transmission direction can be lowered by, switching the transmission direction to the opposite direction and then increasing the amount of transmitted power P withdrawn.

Furthermore, the control unit 50 may adjust the switching frequency f to a value larger than the normal value so as to reduce the transmitted power P transmitted from one of the primary side port and the secondary side port at which the voltage drops. Consequently, even when either one of the primary side port and the secondary side port has a power shortage and thus a reduced port voltage, the reduced port voltage can be raised by reducing the amount of transmitted power P withdrawn.

For example, upon detecting, during transmission of the transmitted power P, a decrease in the port voltage of one of the primary side port and the secondary side port from which the transmitted power P is transmitted, the control unit 50 may adjustably increase the switching frequency f so as to reduce the transmitted power P. Thus, for example, even when an excessive amount of transmitted power P is withdrawn from the transmission source port to lower the voltage of the transmission source port as a result of power shortage, the port voltage of the transmission source can be raised by reducing the amount of transmitted power P withdrawn.

Furthermore, the control unit 50 may adjust the switching frequency f to a value larger than the normal value so as to reduce the transmitted power P transmitted to one of the primary side port and the secondary side port at which the voltage rises. Consequently, even when either one of the primary side port and the secondary side port has an excessive amount of power and thus an increased port voltage, the increased port voltage can be lowered by reducing the amount of transmitted power P supplied.

For example, upon detecting, during transmission of the transmitted power P, an increase in the port voltage of one of the primary side port and the secondary side port to which the transmitted power P is transmitted, the control unit 50 may adjustably increase the switching frequency f so as to reduce the transmitted power P. Thus, for example, even when an excessive amount of transmitted power P is supplied to the transmission destination port to raise the voltage of the transmission destination port as a result of excessive power, the port voltage of the transmission destination can be lowered by reducing the amount of transmitted power P supplied.

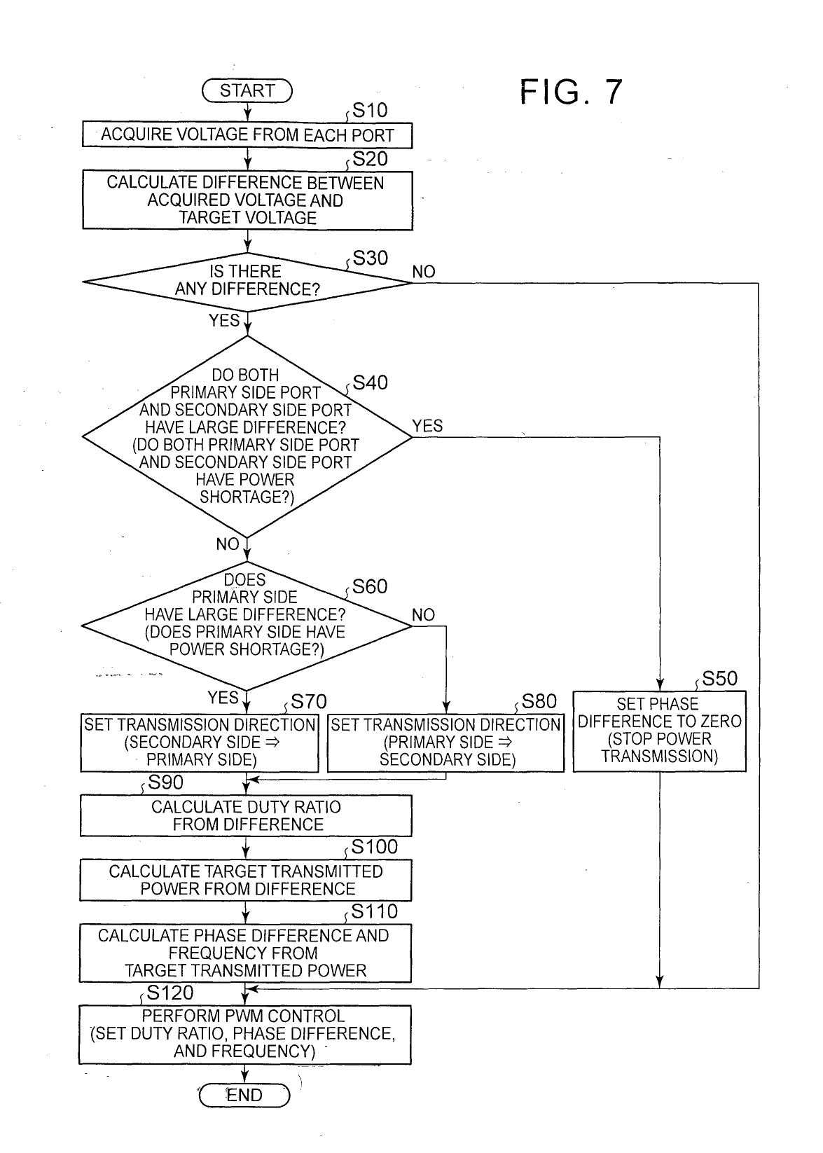

FIG. 7 is a flowchart showing an example of a power conversion method.

FIG. 7 shows an example of a flowchart of a case in which the control unit 50 increases the transmitted power P on the basis of detection of a decrease in the port voltage.

In step S10, the control unit 50 acquires the port voltages Va, Vb, Vc, and Vd of the first to fourth input/output ports 60a, 60b, 60c, and 60d via the sensor unit 70. The port voltage need not be acquired from any unused input/output port to which no load or power supply is connected (for example, the fourth input/output port 60d).

In step S20, the control unit 50 calculates a difference E between the detected port voltage of each of the input/output ports acquired in step S10 and a target voltage set for the input/output port.

Upon determining, in step S30, that none of the differences E between the detected port voltages of all the input/output ports and the respective target voltages is equal to or larger than a predetermined value, the control unit 50 sets, in step S120, the duty ratio D, the phase difference φ, and the switching frequency f to respective normal values. The control unit 50 adjusts the transmitted power P by performing pulse width modulation (PWM) control on the primary side conversion circuit 20 and the secondary side conversion circuit 30 in accordance with Equation 1 reflecting the normal values. Step 120 in this case involves processing performed by the control unit 50 after steps S90 and S110 described below to return the duty ratio D, the phase difference φ, and the switching frequency f from the values determined in steps S90 and S110 to the predetermined normal values.

On the other hand, in step S30, upon determining that any of the input/output ports has a difference E equal to or larger than the predetermined value between the port voltage of the input/output port and the target voltage, the control unit 50 performs processing in step S40 and the subsequent steps. In step S40, the control unit 50 determines which of the input/output ports has the difference E equal to or larger than the predetermined value to determine whether or not transmission of the transmitted power P is possible.

Upon determining, in step S40, that both the primary side circuit and the secondary side port have the difference E equal to or larger than the predetermined value, the control unit 50 sets the phase difference φ to zero in step S50. This stops the transmission of the transmitted power P. After the processing in step S50, the control unit 50 sets the duty ratio D and the switching frequency f to the respective normal values in step S120 (the phase difference φ is set to 0 in step S50).

For example, in step S40, when the detected voltage acquired in step S10 is lower than the target voltage by a predetermined value or larger, the control unit 50 determines that both the primary side port and the secondary side port have a power shortage. In this case, in order to prevent either of the ports from having a severer power shortage, the control unit 50 sets the phase difference φ to zero to stop the transmission of the transmitted power P.

On the other hand, in step S40, upon determining that only one of the primary side port and the secondary side port has the difference E equal to or larger than the predetermined value, the control unit 50 performs processing in step S60 and the subsequent steps. In step S60, the control unit 50 determines whether the primary side port or the secondary side port has the difference E equal to or larger than the predetermined value to determine the transmission direction of the transmitted power P.

In step S60, upon determining that the primary side port has the difference E equal to or larger than the predetermined value, the control unit 50 further determines that the primary side port has a power shortage and sets the transmission direction of the transmitted power P to a direction from the secondary side port to the primary side port (step S70). In step S90, the control unit 50 determines the duty ratio D on the basis of the difference E calculated in step S20 in accordance with rules for the relation (for example, a predetermined conversion map or arithmetic expression) between the difference E and the duty ratio D. The control unit 50 then performs processing in step S100 and the subsequent steps.

On the, other hand, in step S60, upon determining that the secondary side port has the difference E equal to or larger than the predetermined value, the control unit 50 further determines that the secondary side port has a power shortage and sets the transmission direction of the transmitted power P to a direction from the primary side port to the secondary side port (step S80). In step S90, the control unit 50 determines the duty ratio D on the basis of the difference E calculated in step S20 in accordance with the rules for the relation (for example, the predetermined conversion map or arithmetic expression) between the difference E and the duty ratio D. The control unit 50 then performs processing in step S100 and the subsequent steps.

In step S100, the control unit 50 derives the target transmitted power Po on the basis of the difference E calculated in step S20. In this case, the target transmitted power Po is power needed as the transmitted power P. The control unit 50 calculates the target transmitted power Po based on the difference E calculated in step S20, for example, in accordance with rules for the relation (for example, a predetermined conversion map or arithmetic expression) between the difference E and the target transmitted power Po.

In step S110, the control unit 50 derives the phase difference φ and the switching frequency f on the basis of the target transmitted power Po calculated in step S100. The control unit 50 calculates the phase difference φ and the switching frequency f based on the target transmitted power Po calculated in step S100, for example, in accordance with rules for the relations (for example, a predetermined conversion map or arithmetic expression) between the transmitted power P and the phase difference φ and the switching frequency f.

In step S120, the control unit 50 sets the duty ratio D, the phase difference φ, and the switching frequency f to the values determined in steps S90 and S110. The control unit 50 performs PWM control on the primary side conversion circuit 20 and the secondary side conversion circuit 30 in accordance with Equation 1 reflecting the set values to adjust the transmitted power P.

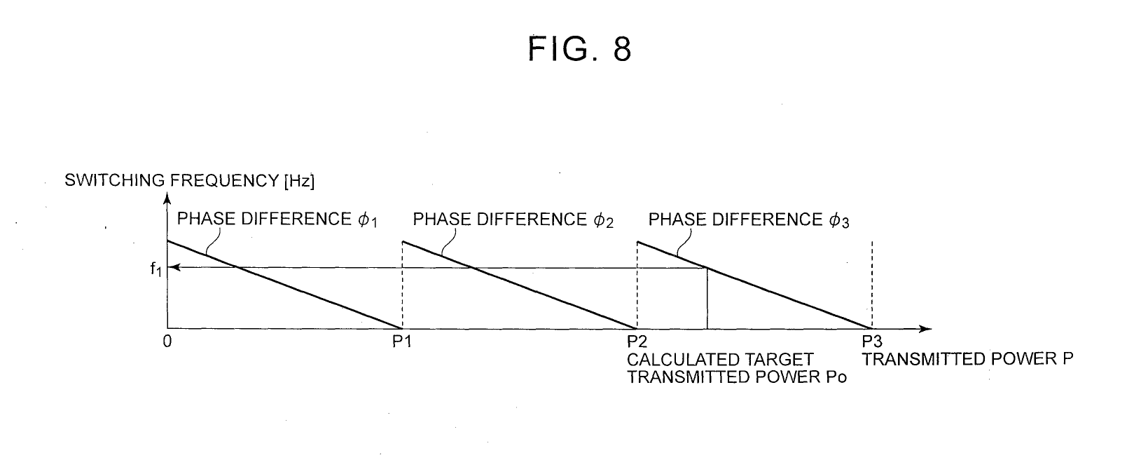

FIG. 8 is a conversion map that is an example of the rules for the relations between the transmitted power P and the phase difference φ and the switching frequency f. The control unit 50 adjusts the phase difference φ to a value selected, on the basis of the target transmitted power Po, from a plurality of phase difference candidates having magnitudes varying in a step-by-step manner. The phase difference φ is limited to values each corresponding to a predetermined range of the target transmitted power Po, thus enabling a reduction in calculation loads on the control unit 50. FIG. 8 illustrates three phase difference candidates φ₁, φ₂, and φ₃ as the plurality of phase difference candidates (φ₁<φ₂<φ₃).

In the conversion map in FIG. 8, the magnitude of the transmitted power P is divided into a plurality of ranges of power. One phase difference φ is set for each of the ranges of power. The switching frequency f is limited to a predetermined range of frequencies, and one switching frequency f is set for each phase difference φ set for the corresponding range of power. Thus, the transmitted power P determined on the basis of the phase difference φ can be fine-tuned using the switching frequency f.

In the case of FIG. 8, the phase difference φ₁ is set for the range of power within which the transmitted power P is equal to or larger than 0 and smaller than P 1. The phase difference φ₂ is set for the range of power within which the transmitted power P is equal to or larger than P1 and smaller than P2. The phase difference φ₃ is set for the range of power within which the transmitted power P is equal to or larger than P2 and smaller than P3. In the case of FIG. 8, the control unit 50 determines the phase difference φ to be φ₃ on the basis of the target transmitted power Po. The control unit 50 determines the switching frequency f to be f₁ on the basis of the phase difference φ₃.

As described above, the control unit 50 determines the target transmitted power Po on the basis of the difference E occurring between the port voltage and the target voltage, and adjusts the phase difference φ and the switching frequency f so as to cause the transmitted power P to converge to the determined target transmitted power Po.

An embodiment of the power conversion apparatus was described above, but the invention is not limited to the above embodiment, and various amendments and improvements, such as combining or replacing the above embodiment either partially or wholly with another embodiment, may be implemented within the scope of the invention.

For example, in the above embodiment, a MOSFET, which is a semiconductor element subjected to an ON/OFF operation, was cited as an example of the switching element. However, the switching element may be a voltage control type power element using an insulating gate such as an insulated gate bipolar transistor (IGBT) or a MOSFET, or a bipolar transistor, for example.

Further, a power supply may be connected to the first input/output port 60a, and a power supply may be connected to the fourth input/output port 60d. Furthermore, a power supply need not be connected to the second input/output port 60c, and a power supply need not be connected to the third input/output port 60b.

1. A power conversion apparatus comprising:
a transformer including a primary side coil and a secondary side coil;
a primary side full bridge circuit including a primary side first arm circuit, a primary side second arm circuit and a primary side magnetic coupling reactor, the primary side first arm circuit connecting a primary side first upper arm and a primary side first lower arm in series, the primary side second arm circuit connecting a primary side second upper arm and a primary side second lower arm in series, the primary side magnetic coupling reactor and the primary side coil provided in a bridge part connecting a midpoint of the primary side first arm circuit to a midpoint of the primary side second arm circuit; and
a secondary side full bridge circuit including a secondary side first arm circuit, a secondary side second arm circuit and a secondary side magnetic coupling reactor, the secondary side first arm circuit connecting a secondary side first upper arm and a secondary side first lower arm in series, the secondary side second arm circuit connecting a second upper arm and a second lower arm in series, the secondary side magnetic coupling reactor and the secondary side coil provided in a bridge part connecting a midpoint of the secondary side first arm circuit to a midpoint of the secondary side second arm circuit;
a primary side port including a first port, the first port provided between a primary side positive bus line and a primary side negative bus line of the primary side full bridge circuit;
a secondary side port including a second port, the second port provided between a secondary side positive bus line and a secondary side negative bus line of the secondary side full bridge circuit;
a control unit configured to adjust a phase difference between a switching timing of the primary side first arm circuit and switching timing of the secondary side first arm circuit and between a switching timing of the primary side second arm circuit and switching timing of the secondary side second arm circuit as a phase difference control such that a transmitted power between the primary side port and the secondary side port is adjusted, and
the control unit-configured to adjust the a frequency of the switching of each of the primary side full bridge circuit and the secondary side full bridge circuit in accordance with a port voltage of at least one of the primary side port and the secondary side port during the phase difference control.

2. The power conversion apparatus according to claim 1, wherein the control unit is configured to adjusts the frequency in such a manner that a change in the port voltage is suppressed using the transmitted power.

3. The power conversion apparatus according to claim 2, wherein the control unit is configured to adjusts the frequency so as to increase the transmitted power transmitted to one of the primary side port and the secondary side port when the port voltage drops.

4. The power conversion apparatus according to claim 3, wherein the control unit is configured to adjusts, when the port voltage of one of the primary side port and the secondary side port to which the transmitted power is transmitted drops during transmission of the transmitted power, the frequency so as to increase the transmitted power.

5. The power conversion apparatus according to claim 3, wherein the control unit is configured to switch, when the port voltage of one of the primary side port and the secondary side port from which the transmitted power is transmitted drops during transmission of the transmitted power, a transmission direction of the transmitted power and to adjusts the frequency so as to increase the transmitted power.

6. The power conversion apparatus according to claim 2, wherein the control unit is configured to adjusts the frequency so as to increase the transmitted power transmitted from one of the primary side port and the secondary side port when the port voltage rises.

7. The power conversion apparatus according to claim 6, wherein the control unit is configured to adjust, when the port voltage of one of the primary side port and the secondary side port from which the transmitted power is transmitted rises during transmission of the transmitted power, the frequency so as to increase the transmitted power.

8. The power conversion apparatus according to claim 6, wherein the control unit is configured to switch, when the port voltage of one of the primary side port and the secondary side port to which the transmitted power is transmitted rises during transmission of the transmitted power, a transmission direction of the transmitted power and to adjusts the frequency so as to increase the transmitted power.

9. The power conversion apparatus according to claim 3, wherein the control unit is configured to reduces the frequency so as to increase the transmitted power.

10. The power conversion apparatus according to claim 1, wherein the control unit is configured to adjusts the frequency in accordance with a voltage difference between the port voltage and a target voltage.

11. The power conversion apparatus according to claim 10, wherein the control unit is configured to adjusts the frequency when the voltage difference is equal to or larger than a predetermined value.

12. The power conversion apparatus according to claim 10, wherein the control unit is configured to adjusts the frequency so as to cause the transmitted power to converge to a target voltage derived on the basis of the voltage difference.

13. (canceled)

14. The power conversion apparatus according to claim 1, wherein the control unit is configured to adjusts the phase difference and the frequency in accordance with a target power for the transmitted power, on the basis of a rule for a relation between the transmitted power, the phase difference and the frequency.

15. The power conversion apparatus according to claim 1, wherein the control unit is configured to adjusts the phase difference to a value selected, on the basis of a target power for the transmitted power, from a plurality of phase difference candidates having magnitudes varying in a step-by-step manner.

16. The power conversion apparatus according to claim 1, herein the control unit is configured to determines whether or not transmission of the transmitted power is possible and determines a transmission direction of the transmitted power, on the basis of a difference between a primary side port voltage of the primary side port and a target voltage for the primary side port voltage, and a difference between a secondary side port voltage of the secondary side port and a target voltage for the secondary side port voltage.
